(19) United States
(12) Patent Application Publication
(10) Pub. No.: US 2010/0184909 A1
(43) Pub. Date: Jul. 22, 2010

(54) CROSSLINKABLE POLYMERS WITH HETEROAROMATIC GROUPS

(75) Inventors: Thomas Möller, Dusseldorf (DE); Melanie Lack, Dusseldorf (DE); Nina Wischnewski, Egolzwil (CH)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/724,604

(22) Filed: Mar. 16, 2010

Related U.S. Application Data
(63) Continuation of application No. PCT/EP2008/061404, filed on Aug. 29, 2008.

(30) Foreign Application Priority Data
Oct. 4, 2007 (DE) 102007047633.9

(51) Int. Cl. C08L 33/10; C08F 28/06; C08F 26/06; C08G 63/688; C08G 63/685; C08G 18/77; C08G 77/28; C08G 77/26; C08L 67/00; C08L 75/04; C08L 83/00; C08L 31/00

(52) U.S. Cl. 524/547; 526/256; 526/263; 528/360; 528/310; 528/73; 528/30; 528/32; 525/55; 525/418; 525/452; 525/474; 524/548; 524/606; 524/599; 524/589; 524/588

(57) ABSTRACT

A crosslinkable binder consisting of a base polymer selected from poly(meth)acrylates, polyesters, polyurethanes, polyamides, polyolefins, polyethers, copolymers of vinyl esters, silicones, wherin the binder has number-average molecular weight (M_{N}) between 500 g/mol and 1 000 000 g/mol and contains at least one crosslinkable thiophene or pyrrole group in covalently bonded form.

The invention relates to polymers that comprise at least one reactive crosslinkable thiophene group and/or pyrrole group. The invention further relates to sealants, adhesives, coating agents, foams or molded parts, which comprise such polymers as the reactive binder. Binders of this type can be crosslinked through the functional groups.

Polymers that are based on heteroaromatic rings are known. They frequently concern polythiophene or polypyrrole compounds. They can crosslink optionally when oxidized. The resulting polymers, however, do not generally show any elastic or flexible properties; rather they are essentially brittle. For example, WO 99/016084 describes an electrically conductive block copolymer, in which one block consists of a conductive polymer and the second block of a non-conductive copolymer. Polymers based on aniline, pyrrole, thiophene, acetylene, furan or indole are described as the conductive polymer block. The conductive polymer should exist in the form of an organic acid. Polymers that only possess heteroaromatic rings not present as a block are not described.

WO 03/018648 describes block copolymers that consist of a block of a conductive polyheteroaromatic polymer and possess at least two blocks of a non-conjugated polymer. Pyrrole, thiophene, pyridine, indole, furan, triazine are described examples of the heteroaromatic monomer. Polymers that selectively comprise only one or two heteroaromatic monomer moieties are not described. The object of the invention is to provide a binder that possesses a crosslinkable group, wherein said binder crosslinks under oxidative conditions and can form a network. In this regard, the resulting crosslinked polymer should possess flexible and/or elastic properties. A further object of the invention is to make available sealing compositions, coating compositions, coating compositions or molded objects, which comprise the inventive binder as the crosslinking component.

The object is achieved by providing a crosslinkable binder, wherein the binder consists of a base polymer, selected from poly(meth)acrylates, polyesters, polyurethanes, polyamides, polyolefins, polyethers, copolymers of vinyl esters or silicones, wherein the binder has a number average molecular weight (M_{N}) between 500 g/mol to 1 000 000 g/mol and comprises at least one covalently bonded crosslinkable thiophene group or pyrrole group.

The binder that comprises the at least one reactive, crosslinkable, heteroaromatic group can be synthesized from known base polymers. When synthesized, said base polymers can comprise an appropriate reactive heteroaromatic group selected from covalently bonded thiophene groups or pyrrole groups, or they concern known base polymers that are modified in a subsequent reaction with at least one thiophene group or pyrrole group.

“Base polymers” in this invention are understood to mean polymers that essentially determine the critical properties for the subsequent application purposes, such as adhesion, tensile strength, temperature behavior or elasticity. Examples of such polymers are thermoplastic polymers. In particular, suitable polymers are copolymers of vinyl esters, such as ethylene-vinyl acetate polymers; polyolefins, e.g. amorphous or semi crystalline polyolefins, propylene or ethylene homo or copolymers, styrene block copolymers, such as SIS, SBS, SIBS-SEBS copolymers, linear or branched thermoplastic polyurethanes; polyamides, such as polyether amides, polyester amides; polyesters, polyethers, poly(meth)acrylates or silicones. Polymers of this type can possess at least one functional group, such as OH, NH, SH, COOH, anhydride, epoxide or NCO groups that are capable of a further reaction, or they are suitably functionalized, for example by grafting reactions. In a preferred embodiment, the base polymers are subsequently modified with functional groups. Here, the heteroaromatic groups are bonded into the polymer by means of covalent bonds. These crosslinkable groups should be present discretely, i.e. they should not be present in the form of thiophene chains or pyrrole chains.

The crosslinkable binders can be varied within wide limits. However, the binders should be liquid at 20° C., be soluble in organic solvents, or should be able to be converted into a free-flowing form by melting at temperatures between 30 and 200° C.

The binders should comprise on average at least one reactive heteroaromatic group. This group can be present in any position on the polymer chain. A preferred embodiment of the present invention comprises at least two reactive thiophene groups or pyrrole groups. When a higher number of crosslinkable groups are bonded in the polymer, then they should each be single thiophene groups or pyrrole groups, which can be statistically distributed over the polymer chain as reacted side-chain groups or found as terminal groups on the polymers. If the number of groups is too high, then on subsequent crosslinking the crosslink density will be too high, and the crosslinked binder will not have adequate elasticity. The number of reactive heteroaromatic groups should be between 1 and 10.

In one embodiment of the invention, thiophene groups can be comprised as the functional group. In another embodiment, base polymers can be manufactured which comprise the pyrrole groups.

The heteroaromatic groups should be covalently bonded on the polymer chain. The heteroaromatic group can be linked directly with the polymer. It is also possible for it to be linked with the polymer through a substituent. It can be unsubstituted covalently bonded heteroaromatic groups. Substituted, for example thiophene groups or pyrrole groups, are also possible.

The heterocyclic functional groups can be compounds of the formula 1 which are bonded onto the base polymer.

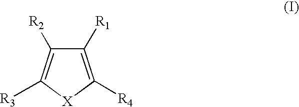

R_{1,2}═H, C₁-C₁₂ alkyl, cycloalkyl, benzyl, aryl, nitrile, —((CH₂)ₐ—O)_{b}R₅, —C(═O)R₆, COOR₆, C₁-C₁₂ alkyl-R₇, C₁-C₁₂ alkyl-Y, cycloalkyl-Y,

R₃═H, C₁-C₁₂ alkyl, cycloalkyl, benzyl, aryl, nitrile, —((CH₂)ₐ—O)_{b}R₅, —C(═O)R₆, COOR₆, C₁-C₁₂ alkyl-R₇, C₁-C₁₂ alkyl-Y, cycloalkyl-Y,

a=2, 3, 4 and 0=1, 2, 3, 4, 5,

R₄═H, CH₃, C₂H₅

R₅═H, CH₃, C₂H₅, C₃H₇, C₄H₉

R₆═H, C₁-C₁₂ alkyl, cycloalkyl, benzyl, aryl

R₇=carbonyl, acetal, ketal, oxime or nitrile

X═S, NH

Y═—OH, —NH, —SH, —COOR₄, anhydride, epoxy,

The substituents R₁, R₂, R₃ and R₄ independently of each other can comprise the corresponding groups. They can be mono- or polysubstituted heterocyclic groups, with the proviso that at least one R₁ to R₄ group is H. Here, the substituents can comprise reactive groups Y, or they can be non-reactive substituted derivatives.

The following are true for various preferred embodiments.

If R₃ possesses a functional group Y, then the R₁ and R₂ groups are non-reactively substituted or are H.

If R₃ possesses a functional group Y and R₄ is methyl or ethyl, then R₁ and/or R₂ are hydrogen.

If R₃ is hydrogen, C₁-C₁₂ alkyl, benzyl, aryl, cycloalkyl, in particular H, methyl, ethyl, then the R₁ and/or R₂ groups can be functionally substituted.

R₁ and R₂ can both possess a preferred identical reactive group Y. However, it is particularly preferred when only one reactive group Y is comprised on the heterocyclic group.

If R₁ and/or R₂ possess a reactive group, then R₃ and preferably R₄ are hydrogen.

It is also possible for R₁ and R₂ to be bridged to one another through alkylene or ether groups.

Furthermore, R₁₋₃ or preferably R₁₋₄ can all be H.

The thiophene group or pyrrole group to be reacted onto the base polymer can be monosubstituted or even polysubstituted monomeric thiophene derivatives or pyrrole derivatives. The substituents R_{1,2,3,4} can be the same or different. Exemplary comprised substituents are C₁-C₁₂ linear, branched or cyclic alkyl groups, e.g. methyl, ethyl or (iso)propyl, cyclohexyl groups; optionally these substituents can also comprise additional non-reactive heteroatoms, such as O, N, S, as ester, ether or amide groups. The substituents can also comprise reactive nucleophilic groups, such as OH, NH or SH groups, or electrophilic groups, such as ester, epoxide or acid anhydride groups. Preferably however, only one R substituent should comprise a reactive group of this type. At least one α-position of the heteroaromatic is preferably unsubstituted. In particular, both α-positions of the thiophene derivative or pyrrole derivative can be unsubstituted.

Exemplary monomeric heteroaromatic compounds of this type are monomeric thiophene derivatives, such as thiophene; alkylthiophenes, such as 2-methyl-, 3-methyl-, 2-ethyl-, 3-ethyl-thiophene; hydroxyalkyithiophenes, such as 2-hydroxymethyl-, 3-hydroxymethyl-, 2-hydroxyethyl-, 3-hydroxyethyl-, 2-hydroxypropyl-, 3-hydroxypropyl-thiophene, or the corresponding glycidyl ethers, amino-substituted thiophenes, such as 2-aminomethyl-ethyl-, 3-aminomethyl-propyl-thiophene; 3,4-ethylenedioxy-thiophene or 3,4-diethyl-thiophene. Exemplary suitable monomeric pyrrole derivatives are pyrrole; alkylpyrroles, such as 3-methyl-, 3-ethyl-, 3-propyl-, 2-ethylpyrrole, 3,4-dimethylpyrrole; hydroxyalkylpyrroles, such as 2-hydroxy- or 3-hydroxymethylpyrrole, 2-hydroxy- or 3-hydroxyethylpyrrole, 2-hydroxy- or 3-hydroxypropylpyrrole or the corresponding glycidyl ethers; 2-methylaminoethyl-, 3-methylaminoethyl-, 2-methylaminopropyl-pyrrole; 3,4-dihydroxymethyl- or 3,4-dihydroxyethyl-pyrrole.

According to the invention, the binder must comprise at least one heteroaromatic group. Said crosslinkable group can be directly reacted in or incorporated during the polymer synthesis. One possibility for the subsequent modification of the base polymer is to react such monomeric thiophene derivatives or pyrrole derivatives onto functional groups of the polymer. In this case, a suitable nucleophilic group of the base polymer can be reacted with an electrophilic group of the heteroaromatic compound, or a nucleophilic group of the heteroaromatic compound is reacted with an electrophilic group of the base polymer. In this way, covalent bonds between polymer and reactant heterocyclic group are obtained.

One working approach involves base polymers that carry electrophilic functional groups. If the base polymer comprises for example ester groups, anhydride groups, acid chloride groups or epoxide groups, then it is possible to react them with an appropriate nucleophilic group in a side chain R of a thiophene derivative or pyrrole derivative, such as OH, SH or NH groups. By choosing the base polymer containing terminal functional groups, then terminally heterocyclic-functionalized binders can be obtained.

A further working approach involves base polymers that carry electrophilic functional groups that are capable of directly acylating the heterocyclic ring system. Exemplary electrophilic groups of this type are acid halides, especially acid chlorides and acid bromides, amides, esters, anhydrides or carboxylic acids.

A further working approach for manufacturing the inventive binders involves base polymers that possess nucleophilic OH, SH or NH groups. Functional groups of this type can then be reacted with an electrophilic group of a monomeric, substituted thiophene derivative or pyrrole derivative, for example with an epoxide, ester or anhydride group. They can then be covalently bonded to the polymer chain under the formation of ester, amide or ether groups.

A preferred embodiment of the invention works on the basis that a base polymer containing an OH, SH or NH group is reacted with diisocyanates. By choosing the reaction conditions it is possible that the base polymer subsequently contains one or a plurality of reactive NCO groups. These NCO-reactive base polymers can be reacted in a subsequent reaction step with such thiophene derivatives or pyrrole derivatives that carry a nucleophilic group. Suitable heterocyclic derivatives generally comprise an OH, NH or SH group.

A particularly preferred working approach for the subsequent modification is that the base polymer contains at least one NCO group. This can be directly reacted with the α-position of a non-reactively substituted thiophene derivative or pyrrole derivative. Here, thiophenes or pyrroles that are not substituted in both α-positions are preferably employed. The heteroaromatic monomer to be reacted can optionally contain activating groups as the substituents. Thiophene or pyrrole can be preferably directly reacted with an NCO-reactive base polymer, thereby affording a covalent bond to an α-position of the heteroaromatic compound.

The monomeric pyrrole derivatives or thiophene derivatives are heterocyclic aromatic compounds that can be manufactured industrially. They are normally present in monomeric form, but in certain cases for technical reasons minor fractions of oligomeric pyrrole, thiophene or their derivatives can be comprised in the starting material and also react.

The reaction of the base polymer with the heteroaromatic monomeric compounds can optionally be carried out in solvents. Depending on the application requirements of the inventive binder, the solvents can be optionally distilled off at a later time. Catalysts can be added to accelerate the reaction. In the case of the reaction of nucleophilic group-containing heteroaromatic compounds with isocyanates, then e.g. known catalysts for isocyanate reactions can be added, for example 2 or 4-valent tin compounds. In the case of the reaction of NCO groups with non-reactively substituted pyrrole or thiophene, then basic catalysts can be added, such as amine-containing or amine-free bases, for example 1,5-diazabicyclo-(4,3,0)-non-5-ene (DBN), 1,8-diazabicyclo-(5,4,0)-undec-7-ene (DBU), 1,4-diazabicyclo-(2,2,2)-octane (DABCO), sodium hydroxide, sodium alcoholate, guanidine, sodium hydride, or basic ion-exchange resins. Catalysis with Lewis acids that accelerate an electrophilic aromatic substitution is also possible. Exemplary catalysts of this type are AlCl₃, ZnCl₂, BF₃, SbCl₅, SnCl₄, TiCl₄, GaCl₃, ZrCl₄, AlBr₃, BCl₃, SbCl₃, aluminum anilide, aluminum phenolates. Protic acids are also suitable such as H₂SO₄, H₃PO₄, polyphosphoric acid, heteropoly acids or cationic ion-exchange resins.

The inventive reactive binders should possess 1 to 10, preferably at least two covalently bonded thiophene or pyrrole groups, especially between 2 and 6. The molecular weight (number average molecular weight (M_{N}) as obtained by GPC) should be between 500 and 1 000 000 g/mol, preferably between 1000 and 200 000 g/mol, especially up to 20 000 g/mol. The binders can be linear, branched or star-shaped, in particular however, linear binders are preferred. They should not be crosslinked, and should be soluble, liquid or melt processable. In general, the binders are themselves not electrically conductive; they are not intrinsically conductive.

The inventive binders comprise one of the abovementioned heteroaromatic groups. In addition, they can even possess other reactive groups. They can be part of the functional groups that were optionally used in order to introduce the heteroaromatic group into the base polymer, e.g. OH or NH groups. However, they can also be functional groups of another type that were not further reacted under the chosen reaction conditions. Examples of such other groups are epoxide groups or unsaturated double bonds.

Binders, wherein the base polymers are selected from polyether polyols, polyester polyols or polyurethane polyols, are a particularly preferred embodiment. Those mixtures consisting of two base polymers of differing composition, wherein both preferably possess at least two covalently bonded, reactive, identical heteroaromatic groups, are also suitable inventive binders.

By means of the inventive manufacturing technique, it is possible to convert the base polymer into thiophene group-containing or pyrrole group-containing binders. In this case, the monomeric heteroaromatic derivatives preferably comprise only one functional group that can react with the base polymer. This technique ensures the absence of any chain extension in this reaction. In a less preferred embodiment, the heteroaromatic groups can also have been reacted in the polymer chain at both ends. For this reaction, the reaction conditions and additives must each be selected so as to ensure the absence of crosslinking or polymerization of the thiophene groups or pyrrole groups used as the monomeric starting material or as the reactive binder. This can be realized, for example, by working under a non-oxidizing atmosphere of protective gas.

The heteroaromatic groups on the inventive base polymer can crosslink. Those thiophene groups or pyrrole groups that do not possess substituents in at least one α-position are particularly suitable. The crosslinking can occur according to known mechanisms, in particular by oxidation. The oxidation can possibly be initiated by oxygen in the ambient air. A further embodiment of the invention uses additives that promote oxidation. For example, they can be compounds that have a high oxidation potential. Examples of such compounds are H₂O₂, iron(III) salts, peroxides, peracids, oxidizing metal salts.

The crosslinking of thiophene derivatives or pyrrole derivatives as the monomer is known in principle. It can be optionally accelerated at increased temperature. Another possibility is to add oxidation catalysts.

The invention further relates to crosslinkable compositions that can be formulated for various applications. For this the inventive binder, after crosslinking, should afford an elastic flexible polymer composition. The amount of the binder depends on the characteristics of the composition; in general it should range between 10 and 90% of the crosslinkable composition. The properties of the binder can be varied within wide limits by the additives and auxiliaries. Exemplary auxiliaries or additives of this type are other inert polymers, resins, plasticizers, waxes, adhesion promoters, catalysts, pigments, fillers, viscosity regulators, solvents, leveling agents, stabilizers or reactive diluents. Such additives are commercially available. By using his knowledge, the person skilled in the art can select them according to the application.

For example, adhesion promoters improve the adhesion to the substrate. The viscosity of the compositions can be reduced by adding plasticizers. Solvents or reactive diluents can likewise lower the viscosity of the uncrosslinked compositions. Catalysts can accelerate the crosslinking reaction. Stabilizers are needed to obtain an improved stability of the crosslinked polymers.

The inventive binders are suitable for various applications. For example, it is possible to manufacture low viscosity adhesives. For this, the inventive binder can be dissolved in organic solvents. They should preferably be volatile solvents that can optionally evaporate at an increased temperature of up to 100° C.

Another application form is a solvent-free adhesive. In this case the viscosity of the binder is low enough for the adhesive to be free flowing at 10 to 40° C. For example, the viscosity can range from 100 mPas to 3000 mPas at the application temperature (Brookfield, EN ISO 2555). Optionally it is possible for the corresponding adhesive to comprise low viscosity reactive diluent in addition to the binder. The term, “reactive diluent” should be understood to mean those monomeric or oligomeric substances that under crosslinking conditions can crosslink with the reactive groups of the binder.

Solvent-free adhesives can likewise be based on the inventive binder. In this case, said adhesives are solid at room temperature and only melt at increased temperatures of 70 to 250° C., especially 100 to 180° C., whereupon they can be applied in this molten form. Crosslinking can then occur after the application.

Casting resins based on the binder are a further application form. These are generally conveyed by pumps, i.e. the compositions should be at least highly viscous or meltable. They are then introduced into the cavity to be filled and can subsequently crosslink.

Another application form employs the inventive binders in sealing compositions. Here, known additives can be added, including for example pigments or fillers. They can be applied in non-crosslinked form but subsequently are intended to crosslink and afford resilient compositions.

Another application form of the inventive binders is a use as coating materials. They can be in-mold coatings, or the surfaces of substrates are furnished with a suitable coating that can be subsequently crosslinked.

Another application form utilizes the inventive binder for manufacturing foamed materials. Here, additives can be added, for example adhesion promoters, catalysts or surface-active substances. The mixture can then, after the incorporation of foaming agents, be converted into a foam, which subsequently crosslinks by oxidation.

The inventive crosslinkable binder that comprises at least one covalently bonded thiophene group or pyrrole group makes possible the use of known polymeric base resins together with a novel crosslinking system. Flexible and/or elastic crosslinked polymer compositions can be obtained in this way.

The inventive adhesives, sealants or coating compositions can be utilized for various applications. Examples of this are the adhesion of composite films for flexible packaging, laminating films onto solid substrates, for example for the furniture industry, adhesives and sealants in the automobile industry, adhesion of glass or ceramics, adhesives and sealants in the construction industry or potting compositions for sealing electronic components.

The inventive manufacturing process provides a technically good access to the inventive binders that comprise crosslinkable heteroaromatic groups. In this regard, the known base polymers are employed and are subsequently provided with the required number of crosslinkable groups. This method enables a cost efficient and simple access to the crosslinkable binders.

The following examples are intended to further exemplify the invention.
CPP-Film: cast polypropylene from Nordenia (50 μm)
PET-Film: polyethylene terephthalate film from Mitsubishi (12 μm)
OPA-Film: oriented polyamide film
Polyol A: liquid polyester diol, OH-number 59

### EXAMPLE 1

200 g of a polyol A were heated under nitrogen to 120° C. and degassed under a pressure of less than 10 mbar for one hour. At 90° C. under an atmosphere of dry nitrogen, 51.5 g MDI were then added with stirring. When the NCO value reached 3.09%, 31.5 g thiophene were added. The mixture was stirred until the NCO number reached <0.1%. Excess thiophene was stripped off under vacuum.

Care must be taken to ensure that the starting materials and the polymer are manufactured and stored under the exclusion of oxygen.

Viscosity at 125° C., 8500 mPas (cone-plate viscosimeter)

### EXAMPLE 2

400 g of a polyol A were heated under nitrogen to 120° C. and degassed under a pressure of less than 10 mbar for one hour. At 90° C. under an atmosphere of dry nitrogen, 105.8 g MDI were then added with stirring. When the NCO value reached 2.95%, 47.5 g pyrrole were added. The mixture was stirred until the NCO number reached <0.1. Excess pyrrole was stripped off under vacuum.

Care must be taken to ensure that the starting materials and the polymer are manufactured and stored under the exclusion of oxygen.

Viscosity at 125° C., 14700 mPas (cone-plate viscosimeter)

### EXAMPLE 3

The polymer from example 1 or 2 was dissolved in ethyl acetate; the solids content was 35%. A film was cast from this solution and the solvent evaporated.

The film thickness was 0.5 to 1 mm.

Both polymer films crosslinked within 48 hours to afford a dry and tough elastic film.

### EXAMPLE 4

A thin layer from the solutions of example 3 was coated onto a PET film by means of a spiral blade (K-hand coater 620 from Erichsen Co.). Most of the solvent was evaporated by blowing with a hair-dryer for 3 minutes. A corona surface-treated CPP film was then uniformly and bubble-free pressed with a pressure roller. The composite film was stored for 7 days at room temperature and was then crosslinked.

The bond strength was tested on 15 mm wide strips by a 90° C. peal test (Instron 4301, ASTM D 1876) at a pulling speed of 100 mm/min. Material failure of the film was observed in both bondings.

An OPA film was similarly bonded with a CPP film. Material failure of the films was observed.

### Example 5

Beech wood sample specimens (Rocholl Co.) were bonded together with an adhesive according to example 3 with an overlap length of 10 mm. The substrates were stored at room temperature for 14 days. A tensile lap-shear strength (DIN 53504) of ca. 7.2 N/mm² was measured.

1. Crosslinkable binder consisting of a base polymer, selected from poly(meth)acrylates, polyesters, polyurethanes, polyamides, polyolefins, polyethers, copolymers of vinyl esters, and silicones, wherein the binder has a number average molecular weight (M_{N}) between 500 g/mol to 1 000 000 g/mol and comprises at least one covalently bonded crosslinkable thiophene group or pyrrole group.

2. Crosslinkable binder according to claim 1 wherein the binder has at least two thiophene groups or pyrrole groups, wherein said groups are singly placed.

3. Crosslinkable binder according to claim 1 wherein the binder has side-chain or especially terminal thiophene groups or pyrrole groups.

4. Crosslinkable binder according to claim 1 wherein the molecular weight is from 1000 g/mol to 200 000 g/mol.

5. Crosslinkable binder according to claim 1 wherein the binder is present in liquid form in a range of 20 to 200° C. or is dissolved or can be molten.

6. Crosslinkable binder according to claim 1 wherein the bonded thiophene groups or pyrrole groups possess at least one unsubstituted α-position.

7. Crosslinkable binder according to claim 1 wherein the base polymer possesses NCO groups that have been reacted with an OH—, SH—, NH—, COOH-functional thiophene derivative or pyrrole derivative or with α,α′-unsubstituted thiophene derivatives or pyrrole derivatives.

8. Crosslinkable binder according to claim 7 wherein the base polymer comprises covalently bonded unsubstituted thiophene groups or pyrrole groups as the functional group.

9. Crosslinkable binder according to claim 1 wherein the binder consists of a mixture of different base polymers that each comprise at least one crosslinkable covalently bonded thiophene group or pyrrole group.

10. Crosslinkable binder according to claim 1 wherein the binder is crosslinkable by oxidation.

11. Process for manufacturing a binder according to claim 1 wherein
the base polymer possesses at least one reactive functional group,
an optionally substituted thiophene derivative or pyrrole derivative is selected that possesses a reactive group that can react with the functional group of the base polymer, and
the functional groups are converted to covalently bonded thiophene groups or pyrrole groups on the polymer chain.

12. Process according to claim 11 wherein a base polymer is selected that possesses an OH, SH or NH group, said group is treated with a diisocyanate to form a reaction product that possesses at least one isocyanate group, and is further treated with a compound selected from α-unsubstituted thiophene derivatives or pyrrole derivatives, which comprise no further isocyanate-reactive groups, or with substituted thiophene derivatives or pyrrole derivatives, which in one of the groups R₁ to R₄ comprise a reactive group that is capable of reacting with an NCO group.

13. Process according to claim 11 wherein the reaction is carried out in an organic solution.

14. Process according to claim 11 wherein the reaction is carried out in the presence of catalysts.

15. Process according to claim 11 wherein on average two to six thiophene groups or pyrrole groups per polymer are covalently bonded.

16. Process according to claim 11 wherein the thiophene derivative or pyrrole derivative is added in an amount such that after a reaction, further unreacted functional groups are present on the base polymer.

17. Process according to claim 11 wherein the reaction is carried out under the exclusion of oxidizing agents such as oxygen.

18. Crosslinkable composition comprising a crosslinkable binder according to claim 1, as well as at least one oxidation catalyst that catalyzes the crosslinking reaction between the thiophene groups or pyrrole groups, as well as optional additional auxiliaries and additives.

19. Crosslinkable composition according to claim 18 wherein the additives are selected from plasticizers, resins, waxes, pigments, fillers, adhesion promoters, stabilizers, light stabilizers, solvents, and non-reactive thermoplastic polymers.

20. Crosslinkable composition according to claim 18 wherein the composition is free of solvent and can be converted into a molten state at temperatures of up to 200° C.

21. Composition according to claim 18 wherein the composition is liquid at temperatures of up to 40° C.
